(19) United States
(12) Patent Application Publication
(10) Pub. No.: US 2005/0129868 A1
(43) Pub. Date: Jun. 16, 2005

(54) Repair of zirconia-based thermal barrier coatings

(75) Inventors: Vinod Philip, Orlando, FL (US); Sudipta Seal, Oviedo, FL (US); Weifeng Fei, Orlando, FL (US); Satyajit Shukla, Orlando, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/733,740

(22) Filed: Dec. 11, 2003

(51) Int. Cl. H05H 1/26; B32B 35/00

(52) U.S. Cl. 427/452; 427/453; 427/140

(57) ABSTRACT

A method of depositing a zirconia-based ceramic coating (24) using a low velocity oxy-fuel (LVOF) process. Particles of zirconia (14) are mixed with second constituent particles (16) of a material having a melting temperature sufficiently low to be successfully deposited by an LVOF process. The second constituent particles may have a coefficient of thermal expansion within 30% of that of the zirconia particles, and/or they may have a thermal conductivity less than or no more than 20% higher that that of the zirconia particles. The second constituent particles may include calcium titanate, strontium titanate or sodium-zirconium-phosphate-silicate (NZPS). The capability to deposit the zirconia-containing particle mix with an LVOF process facilitates the in-situ repair of a component having a damaged zirconia-based thermal barrier coating.

### FIELD OF THE INVENTION

This invention relates generally to the field of materials and more particularly to ceramic thermal barrier coatings.

### BACKGROUND OF THE INVENTION

Thermal barrier coating materials are commonly used to protect underlying substrate materials from a high temperature environment. In modern gas turbine engines, hot gas path components formed of metal alloys such as nickel-based or cobalt-based superalloys are often coated with a layer of ceramic insulating material. Zirconia-based coatings, in particular 6-8% yttria stabilized zirconia (YSZ), is a material that is widely used for such applications. Zirconia may be deposited onto the substrate surface by a variety of processes, including for example plasma spray or physical vapor deposition (PVD). Plasma spray provides a coating formed of multiple overlapping splats of previously molten material. Physical vapor deposition provides a columnar-grained structure that may perform better than plasma sprayed coatings in certain applications due to an enhanced porosity control (lower thermal conductivity) and improved strain tolerance due to the inherent directionality of its structure (improved thermal shock performance).

Methods for repairing damaged ceramic thermal barrier coatings are known. U.S. Pat. No. 5,723,078 describes the use of a plasma spray process to repair a columnar-grained coating. The extremely high temperatures produced during a plasma spray process, as high as 15,000° C. for example, necessitate that such repairs be performed in a shop environment following disassembly of the machine containing the component to be repaired. U.S. Pat. No. 6,413,578 describes the use of a ceramic paste that can be applied to a damaged gas turbine component while the component remains installed. The paste includes a ceramic powder and a binder material that is thermally reacted to form the repair. Such chemically bonded repair materials generally do not perform as well as the original coating material, especially under conditions of cyclic thermal exposures.

U.S. Pat. No. 4,588,655 describes a ceramic coating consisting of alumina and zirconia particles, and U.S. Pat. No. 5,059,095 describes applying a dense coating of this material to a gas turbine rotor blade tip using a high velocity oxy-fuel (HVOF) process. The dense layer of alumina-zirconia material is useful for a gas turbine blade tip application due to its friction and abrasion qualities.

### BRIEF DESCRIPTION OF THE DRAWINGS

FIG. 1 is a schematic illustration of a portable low velocity oxy-fuel tool being used to deposit a ceramic coating on a surface of a component that is in its operating position in a machine.

FIG. 2 is a partial cross-sectional illustration of a ceramic coating obtained by depositing a relatively low melting point powder and a relatively high melting point powder using a low velocity oxy-fuel process.

### DETAILED DESCRIPTION OF THE INVENTION

The present inventors have found that prior art coatings of alumina and zirconia applied by thermal processes such as air plasma spray (APS) or high velocity oxy-fuel (HVOF) have a life expectancy that is less than that of zirconia coatings not containing alumina due to spalling caused by the differential thermal expansion between the zirconia and the alumina. Furthermore, the thermal conductivity of such coatings is higher than that of pure zirconia coatings. An improved coating is described herein as combining zirconia (unstabilized or stabilized) with a material having a coefficient of thermal expansion and/or a thermal conductivity that is closer to that of zirconia than the corresponding property of alumina. The coefficient of thermal expansion of the material that is mixed with the zirconia may be within 30% of that of the zirconia in one embodiment, or within 20% or 10% of that of the zirconia in other embodiments. The thermal conductivity of the material may be no more than that of the zirconia in one embodiment, or no more than 20% higher than that of the zirconia in another embodiment. The coefficient of thermal expansion may be an important variable in the selection of the mix material in applications where coating life is a primary concern. In applications where thermal protection is a primary concern, the thermal conductivity may become a more important consideration to be balanced against coating life. The mix material combined with zirconia advantageously has an incipient melting point sufficiently low so that particles of the material are at least partially melted during a low velocity oxygen fuel (LVOF) process so that the combined particle mix may be applied to a component of a machine such as a gas turbine by using LVOF equipment. The low velocity oxygen fuel process may be an oxy-acetylene flame spray (OFS), for example, or it may be a low velocity oxy-fuel process that utilizes hydrogen or other fuel.

The coefficient of thermal expansion (10 e⁶/° K.), thermal conductivity (W/mK) and melting point (° C.) of 8% yttria stabilized zirconia (8YSZ), alumina (Al₂O₃), calcium titanate (CaTiO₃), strontium titanate (SrTiO₃) and sodium-zirconium-phosphate-silicate (NZPS) are as shown in Table 1. NZPS is a family of materials that can have several different stoichiometries. The values provided in Table 1 are for the specific combination of Na₃Zr₂Si₂PO₁₂, although other stoichiometries of NZPS are included within the scope of the present invention.

TABLE 1

| MATERIAL | COE 10e⁻⁶/° K. | conductivity W/mK | MP ° C. |
|---|---|---|---|
| 8YSZ | 12.0 | 2.0 | 2,700 |
| Al₂O₃ | ˜8.0 | ˜30 | 2,100 |
| CaTiO₃ | ˜14.0 | 4.4 | 1,975 |
| SrTiO₃ | ˜11.4 | 2.3 | 2,080 |
| NZPS | ˜6 | 1.75 | 1,275 |

Both calcium titanate and strontium titanate exhibit coefficients of thermal expansion that are closer to that of zirconia than that of alumina. The thermal conductivities of these materials are also close to that of the zirconia, especially when compared to the thermal conductivity of alumina, which is much higher than (an order of magnitude higher than) that of zirconia. The melting points of these materials are all lower than that of alumina and are sufficiently low so that particles of these materials that are delivered by a low velocity oxy-fuel process will be completely or at least partially melted to a degree sufficient to allow the materials to be effectively applied by this process.

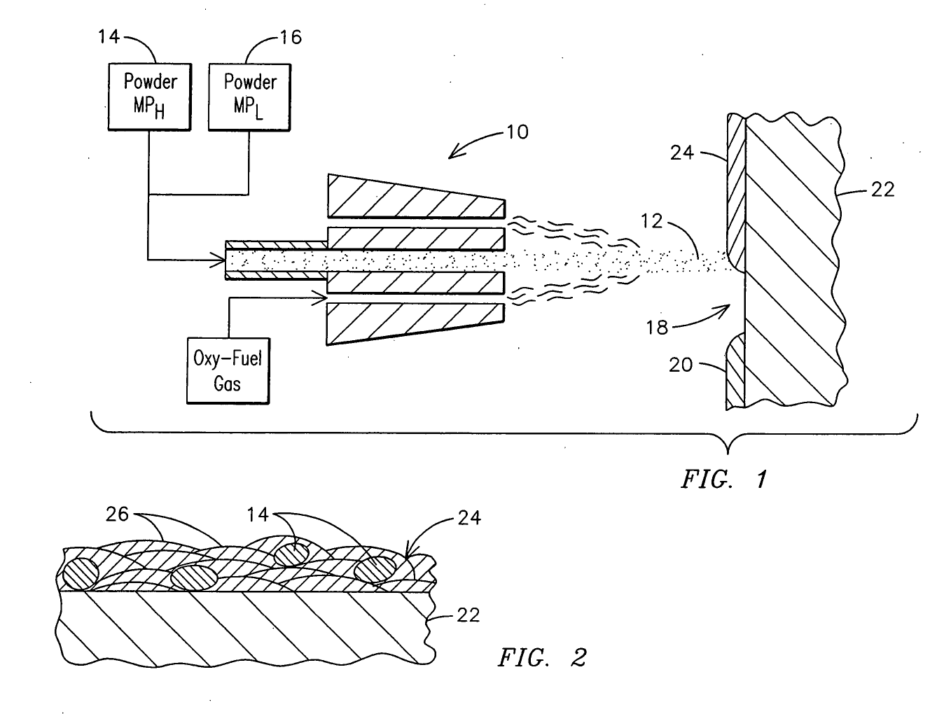

FIG. 1 illustrates a low velocity oxy-fuel system 10 being used to spray a composite powder 12. The composite powder 12 may include a first constituent 14 that is a relatively high melting point ceramic material that normally cannot be applied with a LVOF process, for example either stabilized or unstabilized zirconia. The composite powder 12 also includes a second constituent 16 that is a relatively low melting point ceramic material that can be at least partially melted or fully melted and successfully applied by a LVOF process, for example calcium titanate or strontium titanate. The two constituents are mixed together to form a homogeneous mixture prior to spraying, such as by ball milling or by wet chemical mixing. The portion of the composite powder 12 that is the low melting temperature material may range from less than or at least 20 vol. % to 40 vol. %, or more, of the composite powder 12. While the proportions may vary for different materials and application temperature ranges, for the specific application of a gas turbine hot gas path component, the proportion of low-melting component will generally fall within the range of 20-40 vol. %. Particle sizes may be selected to ensure the proper operation of the LVOF system 10, such as in the range from −120+325 mesh, from −140+325 mesh, or from −150+325 mesh for example.

Prior art low velocity oxy-fuel processes have not been used successfully to deposit zirconia due to the high melting point of zirconia. The prior art thermal spray processes used to apply zirconia coatings have included high velocity oxy-fuel (HVOF) and plasma spray. These processes are not useful for in-situ repairs of machines such as gas turbines due to the high temperature, high particle velocity, and/or high sound energy levels produced. The Figure illustrates a damaged region 18 of an existing coating 20 on a component 22 being repaired by the deposition of a repair coating 24 with the component 22 in place in its operating position within a machine of which it forms a part. Access is provided to the damaged region 18 without removing the component 22 from the machine. The damaged region may be cleaned with any known cleaning process, such as by grit blasting or chemical cleaning. The repair coating 24 may be applied onto the substrate 22, onto a bond coat layer (not shown) covering the substrate 22, or onto a portion of the existing coating 20. Repair coating 24 may be applied to any desired thickness, such as in the range of 8-35 mils, for example.

The coefficient of thermal expansion of sodium-zirconium-phosphate-silicate is lower than that of alumina. However, NZPS does exhibit a thermal conductivity that is lower than that of both alumina and zirconia, and it also has the lowest melting temperature of the materials described above. NZPS may be selected as the low-melting temperature powder 16 for applications where thermal conductivity is especially important.

One may appreciate that it is possible to use a LVOF process to apply a variety of relatively high melting temperature ceramic powders 14 that are normally not successfully applied with LVOF by combining the high melting temperature powder 14 with a low melting temperature powder 16 in the LVOF process. A typical cross-section of the resulting coating 24 is illustrated in FIG. 2. The lower melting temperature constituent 16 has been at least partially melted by the spray process and has re-solidified to form splats 26. The splats 26 surround and encase the unmelted or potentially partially melted particles of the high melting temperature material 14. Complete melting of the low melting temperature particles 16 is not necessary. Surface melting of the particles 16 is sufficient. It may be difficult to quantify a specific amount of melting because a number of variables can affect the coating microstructure. Test data may be useful for identifying an acceptable microstructure for a particular application. The two constituent particles 14, 16 will sinter during a subsequent high temperature heat treatment and/or during the subsequent operation of the component. The resulting coating 24 is relatively porous when compared to a plasma sprayed coating (typically 10-15% void fraction), with a typical void percentage being in the range of 20-25%.

While various embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A method of applying a zirconia-based thermal barrier coating, the method comprising:
selecting a composite powder comprising a first constituent comprising stabilized zirconia particles and a second constituent comprising particles of a ceramic material having a melting temperature sufficiently low so that the second constituent particles at least partially melt when applied with a low velocity oxygen fuel process; and
using the low velocity oxygen fuel process to apply the composite powder to a surface.

2. The method of claim 1, further comprising selecting the second constituent to comprise particles of calcium titanate.

3. The method of claim 1, further comprising selecting the second constituent to comprise particles of strontium titanate.

4. The method of claim 1, further comprising selecting the second constituent to comprise particles of sodium-zirconium-phosphate-silicate.

5. A method of applying a zirconia-based thermal barrier coating, the method comprising:
selecting a composite powder comprising a first constituent comprising zirconia particles and a second constituent comprising particles of a ceramic material having a melting temperature sufficiently low so that the second constituent particles at least partially melt when applied with a low velocity oxygen fuel process: and
using the low velocity oxygen fuel process to apply the composite powder to a surface;
further comprising applying the composite powder to the surface of a component without removing the component from a machine of which it forms a part.

6. The method of claim 1, further comprising selecting the second constituent to comprise at least 20% by volume of the composite powder.

7. The method of claim 6, further comprising selecting the second constituent to comprise from 20-40% by volume of the composite powder.

8. The method of claim 1, further comprising selecting the second constituent to comprise a material exhibiting a coefficient of thermal expansion within 30% of that of the first constituent.

9. The method of claim 1, further comprising selecting the second constituent particles to comprise a material exhibiting a coefficient of thermal expansion within 20% of that of the first constituent particles.

10. The method of claim 1, further comprising selecting the second constituent particles to comprise a material exhibiting a coefficient of thermal expansion within 10% of that of the first constituent particles.

11. The method of claim 1, further comprising selecting the second constituent particles to comprise a material exhibiting a thermal conductivity of no more than 20% higher than that of the first constituent particles.

12. The method of claim 1, further comprising selecting the second constituent particles to comprise a material exhibiting a thermal conductivity of less than that of the first constituent particles.

13. A method of repairing a zirconia-based thermal barrier coating, the method comprising:
selecting a composite powder comprising a first constituent comprising zirconia particles and a second constituent comprising particles of a ceramic material having a melting temperature sufficiently low so that the second constituent particles at least partially melt when applied with a low velocity oxygen fuel process;
providing access to a damaged region of a zirconia-based coating on a component of a machine;
cleaning the damaged region; and
using the low velocity oxygen fuel process to apply the composite powder to the damaged region without removing the component from the machine.

14. The method of claim 13, further comprising selecting the second constituent to comprise particles of calcium titanate.

15. The method of claim 13, further comprising selecting the second constituent to comprise particles of strontium titanate.

16. The method of claim 13, further comprising selecting the second constituent to comprise particles of sodium-zirconium-phosphate-silicate.

17. The method of claim 13, further comprising selecting the second constituent to comprise a material exhibiting a coefficient of thermal expansion within 30% of that of the first constituent.

18. The method of claim 13, further comprising selecting the second constituent particles to comprise a material exhibiting a coefficient of thermal expansion within 20% of that of the first constituent particles.

19. The method of claim 13, further comprising selecting the second constituent particles to comprise a material exhibiting a coefficient of thermal expansion within 10% of that of the first constituent particles.

20. The method of claim 13, further comprising selecting the second constituent particles to comprise a material exhibiting a thermal conductivity of no more than 20% higher than that of the first constituent particles.

21. The method of claim 13, further comprising selecting the second constituent particles to comprise a material exhibiting a thermal conductivity of less than that of the first constituent particles.
